(19) United States
(12) Patent Application Publication
(10) Pub. No.: US 2024/0373327 A1
(43) Pub. Date: Nov. 7, 2024

(54) METHOD FOR MONITORING CONTROL CHANNEL, AND DEVICE

(71) Applicant: GUANGDONG OPPO MOBILE TELECOMMUNICATIONS CORP., LTD., Dongguan (CN)

(72) Inventors: Zuomin WU, Dongguan (CN); Wenqiang TIAN, Dongguan (CN)

(21) Appl. No.: 18/771,999

(22) Filed: Jul. 12, 2024

Related U.S. Application Data
(63) Continuation of application No. PCT/CN2022/072206, filed on Jan. 16, 2022.

(51) Int. Cl. H04W 48/12; H04L 5/00; H04W 56/00

(52) U.S. Cl. CPC H04W 48/12; H04L 5/0048; H04W 56/001

(57) ABSTRACT

Provides is a method for monitoring a control channel. The method includes: determining, by a terminal device, a monitoring occasion of a first search space set based on first indication information, wherein the first indication information indicates a configuration of the first search space set, and the first search space set is a search space set corresponding to a first synchronization signal block (SSB), wherein the configuration of the first search space set comprises two monitoring occasions in a first monitoring window associated with the first search space set; and monitoring, by the terminal device, a first control channel corresponding to the first SSB based on the monitoring occasion of the first search space set.

### CROSS-REFERENCE TO RELATED APPLICATION

This application is a continuation of International Application No. PCT/CN2022/072206, filed Jan. 16, 2022, the entire disclosure of which is incorporated herein by reference.

### TECHNICAL FIELD

Embodiments of the present disclosure relate to the technical field of mobile communications, and in particular, to a method and apparatus for monitoring a control channel, a method and apparatus for transmitting a control channel, and a device and a medium thereof.

### BACKGROUND

As new radio (NR) systems evolve, research on NR systems may include a new frequency range such as 52.6 GHz to 71 GHz, or 71 GHz to 114.25 GHz. The new frequency range may include a licensed spectrum or an unlicensed spectrum. The new frequency band may alternatively include a dedicated spectrum and a shared spectrum.

### SUMMARY

The present disclosure provides a method and apparatus for monitoring a control channel, a method and apparatus for transmitting a control channel, and a device and a medium. The technical solutions are as follows.

According to some embodiments of the present disclosure, a method for monitoring a control channel is provided.

The method includes: determining, by a terminal device, a monitoring occasion of a first search space set based on first indication information, wherein the first indication information indicates a configuration of the first search space set, and the first search space set is a search space set corresponding to a first SSB, wherein the configuration of the first search space set includes two monitoring occasions in a first monitoring window associated with the first search space set; and monitoring, by the terminal device, a first control channel corresponding to the first SSB based on the monitoring occasion of the first search space set.

According to some embodiments of the present disclosure, a terminal device is provided. The terminal device includes: a processor and a memory storing one or more computer programs. The processor, when loading and running the one or more computer programs, is caused to perform the method for monitoring a control channel as described above.

According to some embodiments of the present disclosure, a network device is provided. The network device includes: a processor and a memory storing one or more computer programs. The processor, when loading and running the one or more computer programs, is caused to perform the method for transmitting a control channel as described above.

### BRIEF DESCRIPTION OF THE DRAWINGS

For clearer descriptions of the technical solutions in the embodiments of the present disclosure, the accompanying drawings required for describing the embodiments are briefly introduced below. Apparently, the accompanying drawings in the following description show merely some embodiments of the present disclosure, and those of ordinary skill in the art may still derive other drawings from these accompanying drawings without creative efforts.

FIG. 1 shows a schematic diagram of Type0-PDCCH CSS monitoring window in the case that M=½ and μ=0, 1, 2, or 3;

FIG. 2 shows a schematic diagram of Type0-PDCCH CSS monitoring window in the case that M=1 and μ=0, 1, 2, or 3;

FIG. 3 shows a schematic diagram of Type0-PDCCH CSS monitoring window in the case that M=2 and μ=0, 1, 2, or 3;

FIG. 4 shows a schematic diagram of Type0-PDCCH CSS monitoring window in the case that M=2 and μ=5 or 6;

FIG. 5 shows a schematic diagram of a communication system according to some exemplary embodiments of the present disclosure;

FIG. 6 shows a flowchart of a method for monitoring a control channel according to some exemplary embodiments of the present disclosure;

FIG. 7 shows a flowchart of a method for monitoring a control channel according to some exemplary embodiments of the present disclosure;

FIG. 8 shows a schematic diagram of a monitoring window associated with Type0-PDCCH CSS corresponding to a first SSB in the case that M=3 and μ=5;

FIG. 9 shows a schematic diagram of a monitoring window associated with Type0-PDCCH CSS corresponding to a first SSB in the case that M=3 and μ=6;

FIG. 10 shows a schematic diagram of a monitoring window associated with Type0-PDCCH CSS corresponding to a first SSB in the case that M=5 and μ=6;

FIG. 11 shows a schematic diagram of a monitoring window associated with Type0-PDCCH CSS corresponding to a first SSB in the case that M=7 and μ=6;

FIG. 12 shows a flowchart of a method for monitoring a control channel according to another exemplary embodiment of the present disclosure;

FIG. 13 shows a schematic diagram of a monitoring window associated with Type0-PDCCH CSS corresponding to a first SSB in the case that X=5 and μ=5;

FIG. 14 shows a schematic diagram of a monitoring window associated with Type0-PDCCH CSS corresponding to a first SSB in the case that X=9 and μ=6;

FIG. 15 shows a flowchart of a method for monitoring a control channel according to another exemplary embodiment of the present disclosure;

FIG. 16 shows a block diagram of an apparatus for monitoring a control channel according to another exemplary embodiment of the present disclosure;

FIG. 17 is a block diagram of an apparatus for transmitting a control channel according to another exemplary embodiment of the present disclosure; and

FIG. 18 is a block diagram of a communication device according to some exemplary embodiments of the present disclosure.

### DETAILED DESCRIPTION

Exemplary embodiments are described hereinafter in detail, examples of which are represented in the accompanying drawings. When the following description relate to the accompanying drawings, the same numerals in different accompanying drawings represent the same or similar elements unless otherwise indicated. Implementations described in the following exemplary embodiments do not represent all implementations consistent with the present disclosure. Rather, the implementations are merely examples of apparatus and methods consistent with some aspects of the present disclosure, as detailed in the appended claims.

It is to be understood that the term “several” refers to one or more, and the term “a plurality of” refers to two or more. The term “and/or” describes the association relationship of the associated objects, and indicates that three relationships may be present. For example, the phrase “A and/or B” means (A), (B), or (A and B). The symbol “/” generally indicates an “or” relationship between the associated objects.

In an NR system, a resource set for transmitting a physical downlink control channel (PDCCH) is called a control resource set (CORESET). One CORESET includes N_{RB} RBs in the frequency domain and N_{symb} symbols in the time domain. N_{RB} and N_{symb} are configured by a network device. One CORESET is associated with one or more search space (SS) sets. One search space set includes one or more control channel elements (CCEs), and a terminal device monitors PDCCH candidates on the CCEs in the search space set.

In an initial access phase, the terminal device does not establish a radio resource control (RRC) connection with the network device, and the terminal device is not configured with a user-specific control channel, but needs to receive common control information in a cell over a common control channel on an initial downlink bandwidth part (BWP), such that a subsequent initial access procedure is completed. For example, a PDCCH transmitted in a type0 PDCCH common search space (Type0-PDCCH CSS) set is configured to schedule a physical downlink shared channel (PDCCH) carrying system information block (SIB) 1, and the search space set thereof is indicated by a pdcch-ConfigSIB1 information field in master information block (MIB) information, or by searchSpaceSIB1 or searchSpaceZero configuration in RRC signaling such as PDCCH-ConfigCommon, and cyclic redundancy check (CRC) for the downlink control information (DCI) format thereof is scrambled by system information radio-network temporary identifier (SI-RNTI). The terminal device monitors PDCCH candidates based on CORESET 0 associated with Type0-PDCCH CSS on the corresponding Type0-PDCCH CSS monitoring occasion, such that scheduling of the corresponding SIB1 information is received.

Specifically, the pdcch-ConfigSIB1 information field includes 8 bits, wherein 4 bits (e.g., low-order 4 bits) indicate the configuration of Type0-PDCCH CSS, and another 4 bits (e.g., high-order 4 bits) indicate the configuration of CORESET 0.

The configuration of CORESET 0 includes: the pattern in which SSB and CORESET 0 are multiplexed, the number of PRBs occupied by CORESET 0, the number of OFDM symbols used for CORESET 0, and the deviation (in RB) of the SSB lower boundary from the CORESET 0 lower boundary in the frequency domain.

The configuration of Type0-PDCCH CSS includes: the values of parameters O and M (for mode 1 only), the index of the first OFDM symbol in the search space, and the number of search spaces in each slot (for mode 1 only).

The parameter O is configured to control the starting location of a monitoring window of a first SSB to avoid the collision of the Type0-PDCCH CSS monitoring window with the SSB.

The parameter M controls the degree of overlapping between monitoring windows of SSB i and SSB i+1, and includes three cases of fully non-overlapping (M=2), overlapping with one slot (M=1), and fully overlapping (M=½).

For mode 1, SSB and CORESET 0 are mapped on different symbols, and the frequency range of CORESET 0 needs to contain SSB. Type0-PDCCH CSS corresponding to one SSB is located within a monitoring window including two slots, wherein each slot includes one Type0-PDCCH CSS monitoring occasion, and the cycle of the monitoring window is 20 ms. The mapping relationship between an SSB with index i and the first slot of a monitoring window corresponding the SSB is as follows:

$$\\ {n}_{0} = ( O \cdot {2}^{{}_{} μ} + ⌊ i \cdot M ⌋ ) mod {N}_{slot}^{{}_{} frame , μ}$$

n₀ is an index of the first slot within the Type0-PDCCH CSS monitoring window in one radio frame, and one radio frame is 10 ms. In the case that └O·2^{μ}+└i·M┘/Nₛₗₒₜ^{frame,μ}┘ mod2=0, the mapping is in the first radio frame (20 ms); and in the case that └O·2^{μ}+└i·M┘/Nₛₗₒₜ^{frame,μ}┘ mod2=1, the mapping is in the second radio frame (20 ms).

μ represents a subcarrier spacing (SCS) parameter corresponding to Type0-PDCCH CSS, and Nₛₗₒₜ^{frame,μ} represents the number of slots in one radio frame in the case that the SCS is configured as μ. In the related art:
in the case that μ=0, 1, 2, or 3 (or, in the case that SCS corresponding to Type0-PDCCH CSS is one of 15 kHz, 30 kHz, 60 kHz, or 120 kHz), two slots in a monitoring window associated with Type0-PDCCH CSS corresponding to SSB i are slot n₀ and slot n₀+1;
in the case that μ=5 (or, in the case that SCS corresponding to Type0-PDCCH CSS is 480 kHz), two slots in a monitoring window associated with Type0-PDCCH CSS corresponding to SSB i are slot n₀ and slot n₀+4; and
in the case that μ=6 (or, in the case that SCS corresponding to Type0-PDCCH CSS is 960 kHz), two slots in a monitoring window associated with Type0-PDCCH CSS corresponding to SSB i are slot n₀ and n₀+8.

Table 1 shows the corresponding SCS size, the number (Nₛₗₒₜ^{frame,μ}) of slots in one radio frame, and the number (Nₛₗₒₜ^{subframe,μ}) of slots in one subframe under different SCS parameters corresponding to Type0-PDCCH CSS.

TABLE 1

| μ | SCS | | Nₛₗₒₜ^{frame, μ} | Nₛₗₒₜ^{subframe, μ} |
|---|---|---|---|---|
| 0 | 15 | kHz | 10 | 1 |
| 1 | 30 | kHz | 20 | 2 |
| 2 | 60 | kHz | 40 | 4 |
| 3 | 120 | kHz | 80 | 8 |
| 4 | 240 | kHz | 160 | 16 |
| 5 | 480 | kHz | 320 | 32 |
| 6 | 960 | kHz | 640 | 64 |

The value of O is {0, 2, 5, 7} for μ=0 or 1, the value of O is {0, 2.5, 5, 7.5} for μ=2 or 3, the value of O is {0, 1.25, 5, 6.25} for μ=5, and the value of O is {0, 0.625, 5, 5.625} for μ=6.

For example, in the case that the SCS is 120 kHz, offset values corresponding to O values of 0, 2.5, 5, or 7.5 are 0 slots, 20 slots, 40 slots, or 60 slots, respectively.

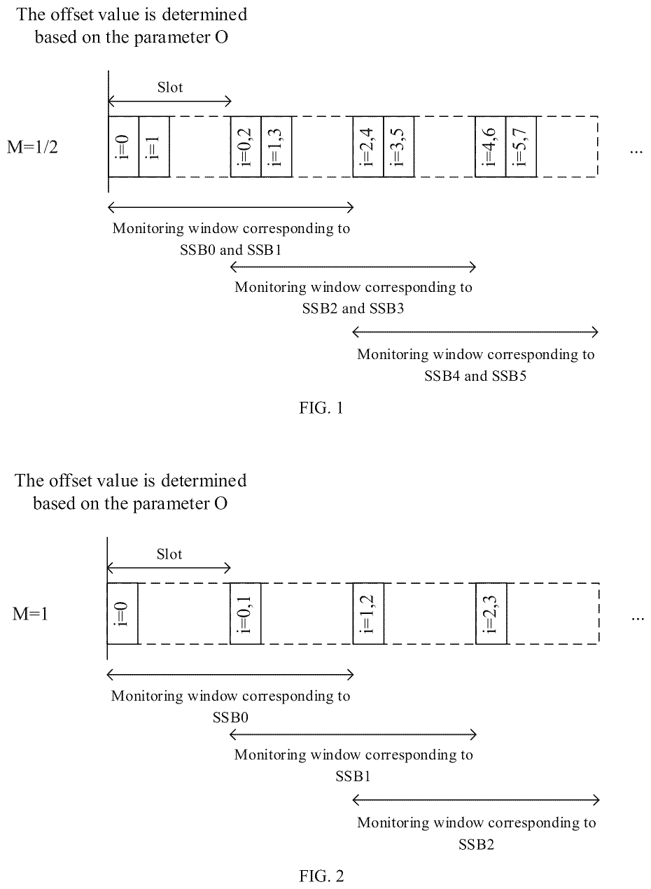

FIGS. 1, 2 and 3 respectively show schematic diagrams of Type0-PDCCH CSS monitoring windows in three cases of M=½, M=1 and M=2 in the case that μ=0, 1, 2, or 3 (or in the case that SCS corresponding to Type0-PDCCH CSS is one of 15 kHz, 30 kHz, 60 kHz or 120 kHz).

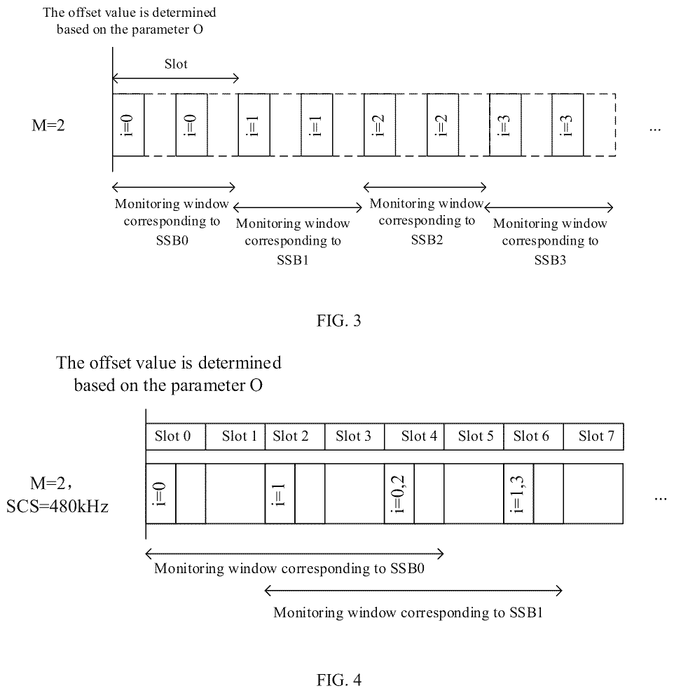

As shown in FIG. 1, in the case that M=½, the starting symbols of two search spaces within one slot are configured as symbols {0, 7} or {0, N_{symb}}; and as shown in FIG. 2 or 3, in the case that M=1 or 2, the starting symbol of the search space on one slot is symbol 0.

In the case that M=½, it is assumed that the starting symbols of two search spaces within one slot are configured as symbols {0, N_{symb}}.

In the case that M=2, each Type0-PDCCH CSS monitoring occasion is only associated with one SSB; and in the case that M=½ or M=1, one Type0-PDCCH CSS monitoring occasion is associated with two SSBs.

In a high frequency system, in the case that μ=5 or 6, even with configuration of M=2, one Type0-PDCCH CSS monitoring occasion may be associated with two SSBs. The description is given by taking μ=5 as an example, and as shown in FIG. 4, assuming that the determined offset value starts from slot 0, two slots in a monitoring window associated with Type0-PDCCH CSS corresponding to SSB 0 are slot 0 and slot 4, two slots in a monitoring window associated with Type0-PDCCH CSS corresponding to SSB 1 are slot 2 and slot 6, and two slots in a monitoring window associated with Type0-PDCCH CSS corresponding to SSB 2 are slot 4 and slot 8, and the like. A Type0-PDCCH CSS monitoring occasion in slot 4 is associated with SSB 0 and SSB 2.

In the related art, in the case that μ=5 or 6, the association of one Type0-PDCCH CSS monitoring occasion with one SSB cannot be configured. Therefore, in the case that μ=5 or 6, how to configure the association of one Type0-PDCCH CSS monitoring occasion with one SSB is a problem to be solved.

The technical solutions according to the embodiments of the present disclosure are applicable to various communication systems, such as a global system of mobile communication (GSM) system, a code division multiple access (CDMA) system, a wideband code division multiple access (WCDMA) system, a general packet radio service (GPRS) system, a long-term evolution (LTE) system, an advanced long-term evolution (LTE-A) system, a new radio (NR) system, an evolution system of an NR system, an LTE-based access to unlicensed spectrum (LTE-U) system, an NR-based access to unlicensed spectrum (NR-U) system, a non-terrestrial networks (NTN) system, a universal mobile telecommunication system (UMTS) system, a wireless local area network (WLAN) system, a wireless fidelity (Wi-Fi) system, a 5^{th} generation (5G) system, or other communication systems, such as a future communication system, e.g., a 6^{th} generation mobile communication system, or a satellite communication system.

Generally, conventional communication systems support a limited number of connections and are easy to implement. However, with the development of communication technologies, mobile communication systems will support not only conventional communications, but also other communications, such as device-to-device (D2D) communications, machine-to-machine (M2M) communications, machine type communications (MTCs), vehicle-to-vehicle (V2V) communications, or vehicle-to-everything (V2X) communications, and the embodiments of the present disclosure are also applicable to these communication systems.

The communication systems in the embodiments of the present disclosure are applicable to a carrier aggregation (CA) scenario, or a dual connectivity (DC) scenario, and further a standalone (SA) networking scenario.

The communication systems in the embodiments of the present disclosure are applicable to an unlicensed spectrum, wherein the unlicensed spectrum is also considered as a shared spectrum; or the communication systems in the embodiments of the present disclosure are also applicable to a licensed spectrum, wherein the licensed spectrum is also considered as a dedicated spectrum.

The embodiments of the present disclosure are applicable to NTN systems, and also terrestrial network (TN) systems. By way of example but not limitation, the NTN systems include NR-based NTN systems and IoT-based NTN systems.

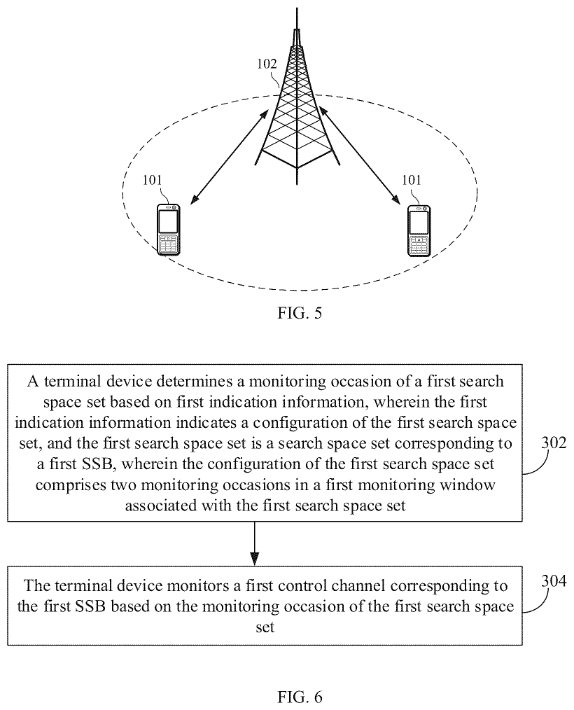

FIG. 5 is a schematic diagram of an architecture of a mobile communication system according to some embodiments of the present disclosure. As shown in FIG. 5, the mobile communication system includes a network device 102. The network device 102 is a device communicating with a terminal device 101 (or referred to as a communication terminal, or a terminal). The network device 102 provides communication coverage for a particular geographic region and communicates with terminals located within the coverage region.

FIG. 5 exemplarily shows one network device 102 and two terminals 101. In some embodiments of the present disclosure, the mobile communication system includes a plurality of network devices 102, and each network devices 102 covers other number of terminals 101, which is not limited in the embodiments of the present disclosure.

In the embodiments of the present disclosure, the terminal 101 is a station (ST) in WLAN, or a cellular phone, a cordless phone, a Session Initiation Protocol (SIP) phone, a wireless local loop (WLL) station, a personal digital assistant (PDA) device, a handheld device with a wireless communication function, a computing device, or another processing device connected to a wireless modem, a vehicle-mounted device, a wearable device, a terminal 101 in a next-generation mobile communication system, such as an NR network, a terminal 101 in an evolved public land mobile network (PLMN), or the like.

In the embodiments of the present disclosure, the terminal 101 is a device providing voice and/or data connectivity for a user, and is configured to be connected to a person, an object, and a machine, such as, a handheld device with a wireless connection function or a vehicle-mounted device. The terminal 101 in the embodiments of the present disclosure is a mobile phone, a tablet computer (or referred to as a Pad), a laptop computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in a smart city, a wireless terminal in a smart home, or the like. In some embodiments, a UE is configured to act as a base station. For example, the terminal 101 acts as a scheduling entity providing a sidelink signal between terminal 101 in V2X, D2D, or the like. For example, a cellular phone and an automobile communicate with each other over a sidelink signal. A cellular phone and a smart home device communicate with each other without relaying a communication signal over a base station.

In the embodiments of the present disclosure, the terminal 101 is deployed on land, for example, indoors or outdoors, handheld, wearable or vehicle-mounted; or deployed on water (for example, a ship); or deployed in the air (for example, an airplane, a balloon, or a satellite).

The terminal 101 according to the embodiments of the present disclosure is also referred to as a terminal, a user equipment (UE), an access terminal, a vehicle-mounted terminal, an industrial control terminal, a UE unit, a UE station, a rover station, a mobile station, a remote station, a remote terminal, a mobile device, a UE terminal, a wireless communication device, a UE agent, a UE device, or the like. The terminal 101 is also stationary or mobile.

By way of example but not limitation, in the embodiments of the present disclosure, the terminal 101 is also a wearable device. The wearable device, also be referred to as a wearable smart device, is a generic name of wearable devices, such as glasses, gloves, watches, clothing, and shoes, which are intelligently designed and developed for daily wear by using wearable technologies. The wearable device is a portable device that is worn directly on the body or integrated into the user's clothing or accessory. The wearable device is not only a hardware device, but also implements powerful functions by software support, data interaction, and cloud interaction. The wearable smart devices in a broad sense include devices such as smart watches or smart glasses that have full functionality and large size, and are capable of implementing all or part of functionality without depending on smart phones, and devices such as various kinds of smart bracelets and smart jewelries for monitoring physical signs, which are dedicated to a specific type of application functions and need to be used in cooperation with other devices such as smart phones.

The network device 102 in the embodiments of the present disclosure is a device configured to communicate with a terminal 101, and the network device 102 may also be referred to as an access network device or a radio access network (RAN) device. For example, the network device 102 is a base station. The network device 102 in the embodiments of the present disclosure refers to a RAN node (or a device) that accesses a terminal 101 to a wireless network. The base station broadly covers or be replaced with various devices as follows: a Node B (NodeB), an evolved NodeB (eNB), a next generation NodeB (gNB), a relay station, an access point, a transmitting and receiving point (TRP), a transmitter point (TP), a master evolved node B (MeNB), a secondary evolved node B (SeNB), a multi-standard radio (MSR) node, a home base station, a network controller, an access node, a wireless node, an access point (AP), a transmitting node, a transmitting and receiving node, a base band unit (BBU), a remote radio unit (RRU), an active antenna unit (AAU), a remote radio head (RRH), a central unit (CU), a distributed unit (DU), a positioning node, and the like. The base station is a macro base station, a micro base station, a relay node, a donor node, or the like, or a combination thereof. The base station may also refer to a communication module, a modem or a chip disposed in the aforementioned devices or apparatuses. The base station is also a mobile switching center, a device that functions as a base station in D2D, V2X and M2M communications, a network-side device in a 6G network, a device that functions as a base station in a future mobile communication system, or the like. The base stations support networks of the same or different access technologies. The embodiments of the present disclosure do not limit the specific technology and the specific device form adopted by the network device 102.

The base station is stationary or mobile. For example, a helicopter or drone is configured to act as a mobile base station. One or more cells move based on the location of the mobile base station. In other examples, a helicopter or drone is configured to serve as a device to communicate with another base station.

In some deployments, the network device 102 in the embodiments of the present disclosure refers to a CU or a DU, or the network device 102 includes a CU and a DU. The gNB further includes an AAU.

The network device 102 and the terminal 101 are deployed on land, for example, an indoors or outdoors, or handheld or vehicle-mounted device or terminal; or are also deployed on water; or are also deployed on airplanes, balloons, and satellites in the air. The embodiments of the present disclosure do not limit the scenarios where the network device 102 and the terminal 101 are used.

By way of example but not limitation, in the embodiments of the present disclosure, the network device 102 has mobile capabilities. For example, the network device 102 is a mobile device. In some embodiments of the present disclosure, the network device 102 is a satellite or a balloon station. For example, the satellites are low Earth orbit (LEO) satellites, a medium earth orbit (MEO) satellites, a geostationary Earth orbit (GEO) satellites, a high elliptical orbit (HEO) satellites, or the like. In some embodiments of the present disclosure, the network device 102 is also a base station deployed on land, water, or the like.

In the embodiments of the present disclosure, the network device 102 provides a service for a cell, and the terminal 101 communicates with the network device 102 over a transmission resource (e.g., a frequency domain resource or a frequency spectrum resource) used by the cell. The cell is a cell corresponding to the network device 102 (e.g., a base station), or the cell is a macro base station or a base station corresponding to a small cell. The small cell includes: a metro cell, a micro cell, a pico cell, a femto cell, or the like. The small cells have the characteristics of small coverage area and low transmit power, and are is applicable to providing high-rate data transmission services.

It should be understood that the “indication” mentioned in the embodiments of the present disclosure may be a direct indication, an indirect indication, or an indication that there is an association. For example, A indicates B, which may mean that A indicates B directly, e.g., B may be acquired by A; or that A indicates B indirectly, e.g., A indicates C by which B may be acquired; or that an association is present between A and B.

In the description of the embodiments of the present disclosure, the term “corresponding” may refer to a direct correspondence or an indirect correspondence that is present between two items, may refer to an association that is present between two items, or may refer to another relationship such as indicating and being indicated, or configuring and being configured.

The “configuration” in the embodiments of the present disclosure includes configuration over at least one of system information, a radio resource control (RRC) signaling, or a media access control-control element (MAC CE).

In some embodiments of the present disclosure, the “predefined” or “preset” is implemented by pre-storing corresponding codes, tables, or other means that may be defined to indicate related information in devices (including, for example, terminal devices and network devices), and the present disclosure does not limit the specific implementation thereof. For example, “predefined” refers to “defined” in a protocol.

In the embodiments of the present disclosure, the “protocol” may refer to a standard protocol in the communication field including, for example, the LTE protocol, the NR protocol, and related protocols applicable to future communication systems, which is not limited in the present disclosure.

The new frequency range may take into account a larger subcarrier spacing than that supported by existing NR systems. For example, the subcarrier spacing may be 480 kHz or 960 kHz. The new frequency band brings new challenges to the configuration of a search space set.

FIG. 6 shows a flowchart of a method for configuring a search space set according to some exemplary embodiments of the present disclosure. Description is given in the embodiments based on an example in which the method is applicable to a terminal device. The method includes at least some of the following processes.

In process 302, a terminal device determines a monitoring occasion of a first search space set based on first indication information, wherein the first indication information indicates a configuration of the first search space set, and the first search space set is a search space set corresponding to a first SSB, wherein the configuration of the first search space set includes two monitoring occasions in a first monitoring window associated with the first search space set.

In the case that the value of a subcarrier spacing parameter μ is greater than 4, one monitoring occasion in the first monitoring window is associated with one SSB.

In some embodiments, the subcarrier spacing parameter μ corresponds to a subcarrier spacing of the first search space set.

In some embodiments, the subcarrier spacing parameter μ corresponds to a subcarrier spacing of the first SSB.

In some embodiments, in the case that the value of μ is 5, the subcarrier spacing of the first search space set is 480 kHz.

In some embodiments, in the case that the value of μ is 6, the subcarrier spacing of the first search space set is 960 KHz.

In some embodiments, the method further includes: receiving, by the terminal device, the first indication information from the network device.

In process 304, the terminal device monitors a first control channel corresponding to the first SSB based on the monitoring occasion of the first search space set.

In summary, in the method according to the embodiments, relevant parameters of the search space set are designed to enable the association of one monitoring occasion of the first search space set with one SSB in the case that the subcarrier spacing is greater than 240 kHz. In this way, the problem in the related art that in the case that the subcarrier spacing is 480 kHz or 960 kHz, one monitoring occasion of each of some search space sets is associated with two SSBs and consequently the association of one monitoring occasion of one search space set with one SSB cannot be configured is addressed.

In some embodiments, the relevant parameters of the first search space set are determined based on at least one of the following two methods.

Method I: The value of a parameter M is configured as an odd number greater than 1.

The parameter M is configured to determine the degree of overlapping between the first monitoring window corresponding to the first SSB and a second monitoring window corresponding to a second SSB.

In some embodiments, an index of the second SSB is an index of the first SSB plus one. In some embodiments, a candidate index of the second SSB is a candidate index of the first SSB plus one.

For example, the first SSB is SSB i and the second SSB is SSB i+1, wherein i represents the index of the first SSB, and i+1 represents the index of the second SSB.

For another example, the first SSB is SSB i and the second SSB is SSB i+1, wherein i represents a candidate index of the first SSB, and i+1 represents a candidate index of the second SSB.

It should be understood that the candidate index of an SSB refers to the index corresponding to the SSB transmitted at the candidate SSB location. SSBs transmitted at different candidate SSB locations have the same quasi co-location (QCL) assumption on the shared spectrum, or different candidate SSB indexes are associated with the same SSB index. The terminal device determines candidate SSB locations having the same QCL assumption based on QCL assumption indication information Q, or the terminal device determines a corresponding relationship between the candidate SSB indexes and the SSB indexes based on Q. By way of example but not limitation, within one discovery burst transmission window (DBTW), the SSB index=(candidate SSB index mod Q), wherein Q is configured or preset by a network device. For example, assuming that the value of Q is 32, according to the formula, a candidate SSB index of an SSB transmitted at candidate SSB location 10 is 10, and an SSB index of the SSB with the candidate SSB index of 10 is 10; and a candidate SSB index of an SSB transmitted at candidate SSB location 42 is 42, and an SSB index of the SSB with the candidate SSB index of 42 is also 10.

Method II: The value of a parameter X is defined as an odd number greater than 1.

The parameter X is the number of time domain units spaced between two monitoring occasions in the first monitoring window. That is, the first monitoring occasion of the two monitoring occasions in the first monitoring window is in the slot n₀, and a second monitoring occasion of the two monitoring occasions in the first monitoring window is in a slot n₀+X.

For method I, the value of the parameter M is configured as an odd number greater than 1.

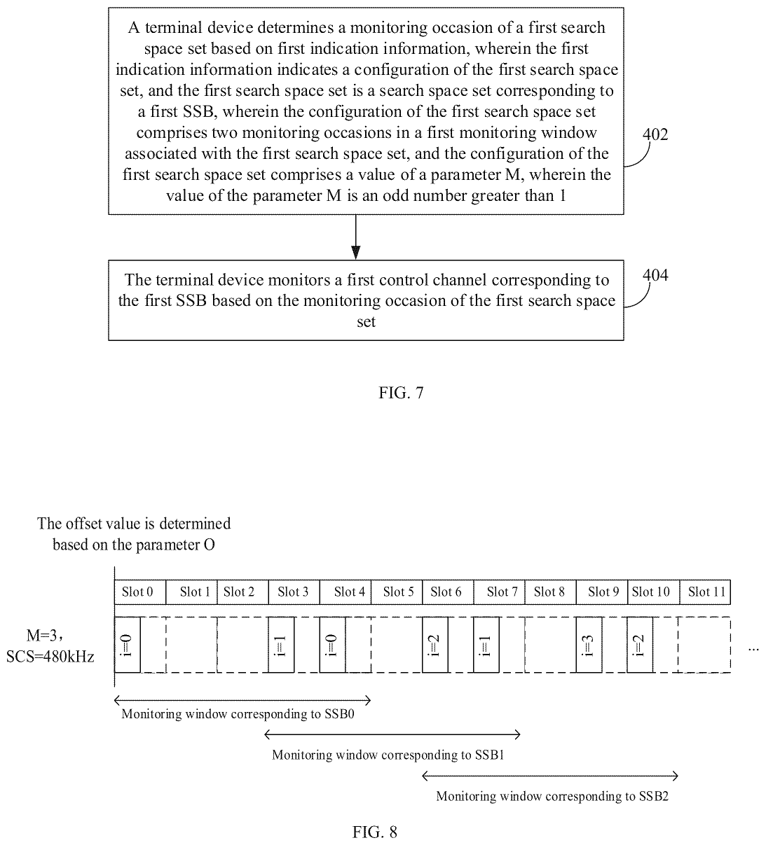

FIG. 7 shows a flowchart of a method for configuring a search space set according to some exemplary embodiments of the present disclosure. Description is given in the embodiments based on an example in which the method is applicable to a terminal device. The method includes the following processes.

In process 402, a terminal device determines a monitoring occasion of a first search space set based on first indication information, wherein the first indication information indicates a configuration of the first search space set, the first search space set is a search space set corresponding to a first SSB, the configuration of the first search space set includes two monitoring occasions in a first monitoring window associated with the first search space set, and the first indication information indicates the value of a parameter M, wherein the value of the parameter M includes an odd number greater than 1.

In some embodiments, the first indication information is carried in MIB information or in an RRC signaling. For example, the RRC signaling is a common configuration for PDCCH (PDCCH-ConfigCommon).

In some embodiments, the first indication information includes pdcch-ConfigSIB1. In some embodiments, the first indication information is carried in MIB information.

In some embodiments, the first indication information includes searchSpaceSIB1 or searchSpaceZero configuration. In some embodiments, the first indication information is carried in PDCCH-ConfigCommon. In some embodiments, the first search space set is Type0-PDCCH CSS.

In some embodiments, the cycle of the first monitoring window is 20 milliseconds.

In some embodiments, in the case that a value of a subcarrier spacing parameter μ is greater than 4, one monitoring occasion in the first monitoring window is associated with one SSB. The subcarrier spacing parameter μ corresponds to the subcarrier spacing of the first search space set.

For example, in the case that the value of μ is 5, the subcarrier spacing of the first search space set is 480 kHz. In the case that the value of μ is 6, the subcarrier spacing of the first search space set is 960 kHz.

In some embodiments, in the case that μ=5 (or, in the case that the SCS corresponding to Type0-PDCCH CSS is 480 kHz), two slots in a monitoring window associated with Type0-PDCCH CSS corresponding to SSB i are slot n₀ and slot n₀+4; and/or, in the case that μ=6 (or, in the case that the SCS corresponding to Type0-PDCCH CSS is 960 kHz), two slots in a monitoring window associated with Type0-PDCCH CSS corresponding to SSB i are slot n₀ and slot n₀+8.

In some embodiments, the first indication information indicates at least one of the following parameters, or the configuration of the first search space set is determined based on at least one of the following parameters: a value of a parameter O; a value of a parameter M; the number of search space sets within each slot; or a starting symbol for each search space set within the slot.

For example, the search space set is Type0-PDCCH CSS, and the configuration of Type0-PDCCH CSS includes at least one of: the value of the parameter O, the value of the parameter M, the number of Type0-PDCCH CSSs within each slot, or the index of the first symbol for each Type0-PDCCH CSS (configured to determine the starting symbol of the Type0-PDCCH CSS in the slot).

In some embodiments, the parameter O is configured to determine the slot n₀ in which the first monitoring occasion of the two monitoring occasions in the first monitoring window is located.

In some embodiments,

$$\\ {n}_{0} = ( O \cdot {2}^{{}_{} μ} + ⌊ i \cdot M ⌋ ) mod {N}_{slot}^{{}_{} frame , μ}$$

i represents the index of the first SSB or the candidate index of the first SSB; u is the subcarrier spacing parameter; and Nₛₗₒₜ^{frame,μ} represents the number of slots in one radio frame determined based on μ.

In some embodiments, the parameter M is configured to determine the degree of overlapping between the first monitoring window corresponding to the first SSB and a second monitoring window corresponding to a second SSB. Taking the first SSB as SSB i as an example, the parameter M is configured to determine the degree of overlapping between the monitoring windows of SSB i and SSB i+1.

In some embodiments, the value of the parameter M in the first search space set includes an odd number greater than 1. In some embodiments, in the case that the value of μ is greater than 4 (in the case that the SCS corresponding to Type0-PDCCH CSS is greater than 240 kHz), the value of the parameter M in the first search space set includes an odd number greater than 1. For example, in the case that μ=5 (in the case that the SCS corresponding to Type0-PDCCH CSS is 480 kHz) or 6 (in the case that the SCS corresponding to Type0-PDCCH CSS is 960 kHz), the value of the parameter M in the first search space set includes an odd number greater than 1. In some embodiments, in this case, the value of the parameter M in the first search space set does not include: M=2.

In some embodiments, in the case that the value of μ is greater than 4, the value of the parameter M in the first search space set includes 3. For example, in the case that μ=5 or 6, the value of the parameter M in the first search space set includes 3. In some embodiments, in this case, the value of the parameter M in the first search space set does not include: M=2.

Table 2 schematically shows the parameters of the PDCCH monitoring window of the corresponding Type0-PDCCH CSS in pattern 1 in which SSB and CORESET are multiplexed and FR2-1 frequency range, in pattern 1 in which SSB and CORESET are multiplexed and FR2-2 frequency range, and in the case that the subcarrier spacing of {SSB, PDCCH} is {120, 120} kHz.

TABLE 2

| | | Number | | |
|---|---|---|---|---|
| | | of search | | |
| | | space | | |
| | | sets in | | |
| Index | O | each slot | M | Index of the first symbol |
| 0 | 0 | 1 | 1 | 0 |
| 1 | 0 | 2 | ½ | {0, if i does not change}, {7, if i increases} |
| 2 | 2.5 | 1 | 1 | 0 |
| 3 | 2.5 | 2 | ½ | {0, if i does not change}, {7, if i increases} |
| 4 | 5 | 1 | 1 | 0 |
| 5 | 5 | 2 | ½ | {0, if i does not change}, {7, if i increases} |
| 6 | 0 | 2 | ½ | {0, if i does not change}, {N_{symb}^{CORESET}, |
| | | | | if i increases} |
| 7 | 2.5 | 2 | ½ | {0, if i does not change}, {N_{symb}^{CORESET}, |
| | | | | if i increases} |
| 8 | 5 | 2 | ½ | {0, if i does not change}, {N_{symb}^{CORESET}, |
| | | | | if i increases} |
| 9 | 7.5 | 1 | 1 | 0 |
| 10 | 7.5 | 2 | ½ | {0, if i does not change}, {7, if i increases} |
| 11 | 7.5 | 2 | ½ | {0, if i does not change}, {N_{symb}^{CORESET}, |
| | | | | if i increases} |
| 12 | 0 | 1 | 3 | 0 |
| 13 | 5 | 1 | 3 | 0 |

| | |
|---|---|
| 14 | Reserved |
| 15 | Reserved |

Table 3 schematically shows the parameters of the PDCCH monitoring window of the corresponding Type0-PDCCH CSS in pattern 1 in which SSB and CORESET are multiplexed and FR2-2 frequency range, and in the case that the subcarrier spacing of {SSB, PDCCH} is {480, 480} kHz or {960, 960} kHz.

TABLE 3

| | | Number | | |
|---|---|---|---|---|
| | | of search | | |
| | | space | | |
| | | sets in | | |
| Index | O | each slot | M | Index of the first symbol |
| 0 | 0 | 1 | 1 | 0 |
| 1 | 0 | 2 | ½ | {0, if i does not change}, {7, if i increases} |
| 2 | X | 1 | 1 | 0 |
| 3 | X | 2 | ½ | {0, if i does not change}, {7, if i increases} |
| 4 | 5 | 1 | 1 | 0 |
| 5 | 5 | 2 | ½ | {0, if i does not change}, {7, if i increases} |
| 6 | 0 | 2 | ½ | {0, if i does not change}, {N_{symb}^{CORESET}, |
| | | | | if i increases} |
| 7 | X | 2 | ½ | {0, if i does not change}, {N_{symb}^{CORESET}, |
| | | | | if i increases} |
| 8 | 5 | 2 | ½ | {0, if i does not change}, {N_{symb}^{CORESET}, |
| | | | | if i increases} |
| 9 | 5 + | 1 | 1 | 0 |
| | X | | | |
| 10 | 5 + | 2 | ½ | {0, if i does not change}, {7, if i increases} |
| | X | | | |
| 11 | 5 + | 2 | ½ | {0, if i does not change}, {N_{symb}^{CORESET}, |
| | X | | | if i increases} |
| 12 | 0 | 1 | 3 | 0 |
| 13 | 5 | 1 | 3 | 0 |

| | |
|---|---|
| 14 | Reserved |
| 15 | Reserved |

In some embodiments, in the case that μ=5, the value of the parameter M in the first search space set includes: M=3. In some embodiments, in this case, the value of the parameter M in the first search space set does not include: M=2. In the case that μ=6, the value of the parameter M in the first search space set includes at least one of M=3, M=5, or M=7. In some embodiments, in this case, the value of the parameter M in the first search space set does not include: M=2.

Taking M=3 as an example, FIG. 8 shows a schematic diagram of a monitoring window associated with Type0-PDCCH CSS corresponding to the first SSB (SSB i) in the case that μ=5. As shown in FIG. 8, it is assumed that the offset value determined based on the parameter O is slot 0 (e.g., O=0). In the case that i=0, the two monitoring occasions in one monitoring window associated with Type0-PDCCH CSS corresponding to SSB 0 are located in slot 0 and slot 4, respectively; in the case that i=1, the two monitoring occasions in one monitoring window associated with Type0-PDCCH CSS corresponding to SSB 1 are located in slot 3 and slot 7, respectively; and in the case that i=2, the two monitoring occasions in one monitoring window associated with Type0-PDCCH CSS corresponding to SSB 2 are located in slot 6 and slot 10, respectively, and the like. In this way, the locations of the two monitoring occasions in one monitoring window associated with Type0-PDCCH CSS corresponding to all SSBs are acquired.

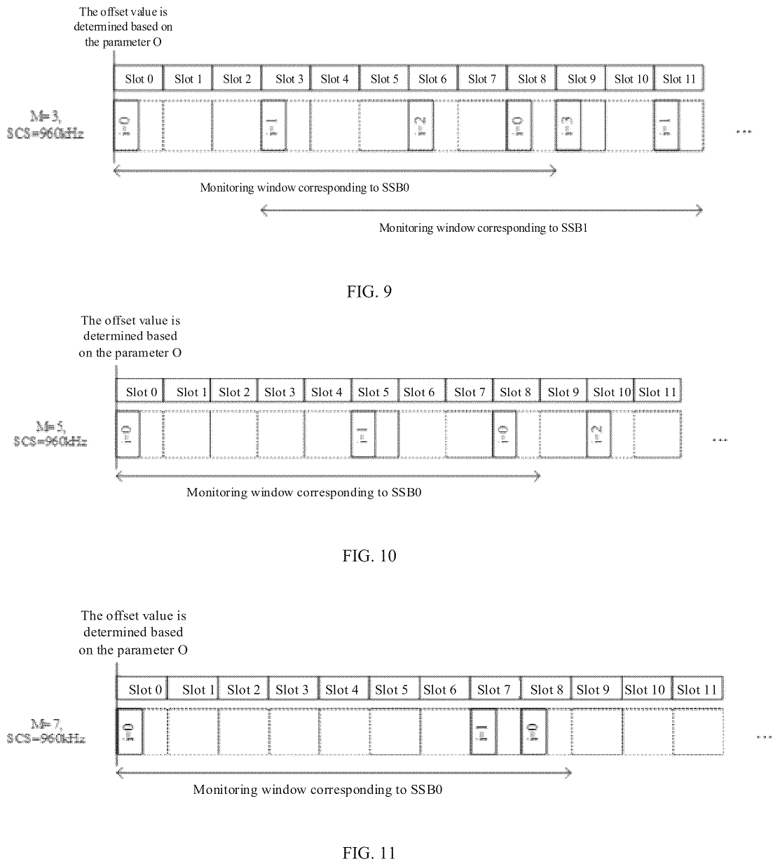

Taking M=3 as an example, FIG. 9 shows a schematic diagram of a monitoring window associated with Type0-PDCCH CSS corresponding to the first SSB (SSB i) in the case that μ=6. As shown in FIG. 9, it is assumed that the offset value determined based on the parameter O is slot 0 (e.g., O=0). In the case that i=0, the two monitoring occasions in one monitoring window associated with Type0-PDCCH CSS corresponding to SSB 0 are located in slot 0 and slot 8, respectively; in the case that i=1, the two monitoring occasions in one monitoring window associated with Type0-PDCCH CSS corresponding to SSB 1 are located in slot 3 and slot 11, respectively; and accordingly, in the case that i=2, the two monitoring occasions in one monitoring window associated with Type0-PDCCH CSS corresponding to SSB 2 are located in slot 6 and slot 14, respectively, and the like. In this way, the locations of the two monitoring occasions in one monitoring window associated with Type0-PDCCH CSS corresponding to all SSBs are acquired.

Taking M=5 as an example, FIG. 10 shows a schematic diagram of a monitoring window associated with Type0-PDCCH CSS corresponding to the first SSB (SSB i) in the case that μ=6. As shown in FIG. 10, it is assumed that the offset value determined based on the parameter O is slot 0 (e.g., O=0). In the case that i=0, the two monitoring occasions in one monitoring window associated with Type0-PDCCH CSS corresponding to SSB 0 are located in slot 0 and slot 8, respectively; accordingly, in the case that i=1, the two monitoring occasions in one monitoring window associated with Type0-PDCCH CSS corresponding to SSB 1 are located in slot 5 and slot 13, respectively; and in the case that i=2, the two monitoring occasions in one monitoring window associated with Type0-PDCCH CSS corresponding to SSB 2 are located in slot 10 and slot 18, respectively, and the like. In this way, the locations of the two monitoring occasions in one monitoring window associated with Type0-PDCCH CSS corresponding to all SSBs are acquired.

Taking M=7 as an example, FIG. 11 shows a schematic diagram of a monitoring window associated with Type0-PDCCH CSS corresponding to the first SSB (SSB i) in the case that μ=6. As shown in FIG. 11, it is assumed that the offset value determined based on the parameter O is slot 0 (e.g., O=0). In the case that i=0, the two monitoring occasions in one monitoring window associated with Type0-PDCCH CSS corresponding to SSB 0 are located in slot 0 and slot 8, respectively; accordingly, in the case that i=1, the two monitoring occasions in one monitoring window associated with Type0-PDCCH CSS corresponding to SSB 1 are located in slot 7 and slot 15, respectively; and in the case that i=2, the two monitoring occasions in one monitoring window associated with Type0-PDCCH CSS corresponding to SSB 2 are located in slot 14 and slot 22, respectively, and the like. In this way, the locations of the two monitoring occasions in one monitoring window associated with Type0-PDCCH CSS corresponding to all SSBs are acquired.

In some embodiments, the first indication information further indicates at least one of the following information: a multiplexing pattern, the number N_{RB} of PRBs occupied by the control resource set, the number N_{symb} of symbols occupied by the control resource set, or the starting location of the control resource set on the frequency domain.

For example, the control resource set is CORESET 0, and the configuration of CORESET 0 includes at least one of: the pattern in which SSB and CORESET 0 are multiplexed, the number N_{RB} of PRBs occupied by CORESET 0, the number N_{symb} of symbols occupied by CORESET 0, or the deviation (in RB, configured to determine the starting PRB of CORESET 0 in the frequency domain) of the SSB lower boundary from the CORESET 0 lower boundary in the frequency domain.

In process 404, the terminal device monitors a first control channel corresponding to the first SSB based on the monitoring occasion of the first search space set.

Based on the configuration of the first search space set, the terminal device monitors the first control channel corresponding to the first SSB based on the monitoring occasion of the first search space set.

In summary, in the method according to this embodiment, in the case that μ=5 or 6, the parameter M is configured as an odd number greater than 1, such that one monitoring occasion of the first search space set is associated with one SSB. In this way, the problem that in the related art, in the case that the subcarrier spacing is 480 kHz or 960 kHz, one monitoring occasion of each of some search space sets is associated with two SSBs and consequently the association of one monitoring occasion of one search space set with one SSB cannot be configured is addressed. For method II: The value of the parameter X is defined as an odd number greater than 1.

FIG. 12 shows a flowchart of a method for configuring a search space set according to some exemplary embodiments of the present disclosure. Description is given in the embodiments based on an example in which the method is applicable to a terminal device. The method includes the following processes.

In process 502, a terminal device determines a monitoring occasion of a first search space set based on first indication information, wherein the first indication information indicates a configuration of the first search space set, and the first search space set is a search space set corresponding to a first SSB, wherein the configuration of the first search space set includes two monitoring occasions in a first monitoring window associated with the first search space set, and the spacing parameter X between two monitoring occasions is an odd number greater than 1.

In some embodiments, the first indication information is carried in MIB information or in an RRC signaling. For example, the RRC signaling is PDCCH-ConfigCommon.

In some embodiments, the first indication information includes pdcch-ConfigSIB1. In some embodiments, the first indication information is carried in MIB information.

In some embodiments, the first indication information includes searchSpaceSIB1 or searchSpaceZero configuration. In some embodiments, the first indication information is carried in PDCCH-ConfigCommon.

In some embodiments, the first search space set is Type0-PDCCH CSS.

In some embodiments, the cycle of the first monitoring window is 20 milliseconds.

In some embodiments, the value of X is predefined or configured by a network device.

In some embodiments, in the case that a value of a subcarrier spacing parameter μ is greater than 4, one monitoring occasion in the first monitoring window is associated with one SSB. The subcarrier spacing parameter μ corresponds to the subcarrier spacing of the first search space set.

For example, in the case that the value of μ is 5, the subcarrier spacing of the first search space set is 480 kHz. In the case that the value of μ is 6, the subcarrier spacing of the first search space set is 960 kHz.

In some embodiments, the first indication information indicates at least one of the following parameters, or the configuration of the first search space set is determined based on at least one of the following parameters:
a value of a parameter O;
a value of a parameter M;
the number of search space sets within each slot; or
a starting symbol for each search space set within the slot.

For example, the search space set is Type0-PDCCH CSS, and the configuration of Type0-PDCCH CSS includes at least one of: the value of the parameter O, the value of the parameter M, the number of Type0-PDCCH CSSs within each slot, and the index of the first symbol for each Type0-PDCCH CSS (configured to determine the starting symbol of the Type0-PDCCH CSS in the slot).

In some embodiments, the parameter O is configured to determine the slot n₀ in which the first monitoring occasion of the two monitoring occasions in the first monitoring window is located.

In some embodiments,

$$\\ {n}_{0} = ( O \cdot {2}^{{}_{} μ} + ⌊ i \cdot M ⌋ ) mod {N}_{slot}^{{}_{} frame , μ}$$

i represents the index of the first SSB or the candidate index of the first SSB; μ is the subcarrier spacing parameter; and Nₛₗₒₜ^{frame,μ} represents the number of slots in one radio frame determined based on μ.

In some embodiments, the parameter M is configured to determine the degree of overlapping between the first monitoring window corresponding to the first SSB and a second monitoring window corresponding to a second SSB. Taking the first SSB as SSB i as an example, the parameter M is configured to determine the degree of overlapping between the monitoring windows of SSB i and SSB i+1. In some embodiments, the value of M is 2. In some embodiments, the value of M is an integer greater than 2.

In some embodiments, the first monitoring occasion of the two monitoring occasions in the first monitoring window is in the slot n₀, and a second monitoring occasion of the two monitoring occasions in the first monitoring window is in a slot n₀+X; and wherein the value of the parameter X includes an odd number greater than 1.

In some embodiments, in the case that the value of the subcarrier spacing parameter μ is 5 (e.g., in the case that the SCS corresponding to Type0-PDCCH CSS is 480 kHz), the value of the parameter X is an odd number greater than 4.

In some embodiments, in the case that the value of the subcarrier spacing parameter μ is 5 (e.g., in the case that the SCS corresponding to Type0-PDCCH CSS is 480 kHz), the value of the parameter X is an odd number greater than 4 and less than 8.

In some embodiments, in the case that the value of the subcarrier spacing parameter μ is 5 (e.g., in the case that the SCS corresponding to Type0-PDCCH CSS is 480 kHz), the value of the parameter X is a smallest odd number greater than 4, that is, the value of the parameter X is 5.

In some embodiments, in the case that the value of the subcarrier spacing parameter μ is 5 (e.g., in the case that the SCS corresponding to Type0-PDCCH CSS is 480 kHz), the value of the parameter X includes one of: 3, 5, or 7.

In some embodiments, in the case that the value of the subcarrier spacing parameter μ is 6 (e.g., in the case that the SCS corresponding to Type0-PDCCH CSS is 960 kHz), the value of the parameter X is an odd number greater than 8.

In some embodiments, in the case that the value of the subcarrier spacing parameter μ is 6 (e.g., in the case that the SCS corresponding to Type0-PDCCH CSS is 960 kHz), the value of the parameter X is an odd number greater than 8 and less than 16.

In some embodiments, in the case that the value of the subcarrier spacing parameter μ is 6 (e.g., in the case that the SCS corresponding to Type0-PDCCH CSS is 960 kHz), the value of the parameter X is a smallest odd number greater than 8, that is, the value of the parameter X is 9.

In some embodiments, in the case that the value of the subcarrier spacing parameter μ is 6 (e.g., in the case that the SCS corresponding to Type0-PDCCH CSS is 960 kHz), the value of the parameter X includes one of: 7, 9, 11, 13, or 15.

In some embodiments, two slots in a monitoring window associated with Type0-PDCCH CSS corresponding to the first SSB (SSB i) are slot n₀ and slot n₀+X, wherein the value of X includes an odd number greater than 1.

In some embodiments, in the case that μ=5, two slots in a monitoring window associated with Type0-PDCCH CSS corresponding to SSB i are slot n₀ and slot n₀+X, wherein the value of X includes an odd number greater than 4. In some embodiments, the value of X includes an odd number greater than 4 and less than 8. In some embodiments, the value of X includes a smallest odd number greater than 4, i.e., X=5.

In some embodiments, in the case that μ=5 (or, in the case that the SCS corresponding to Type0-PDCCH CSS is 480 kHz), the value of X includes at least one of X=3, X=5, or X=7.

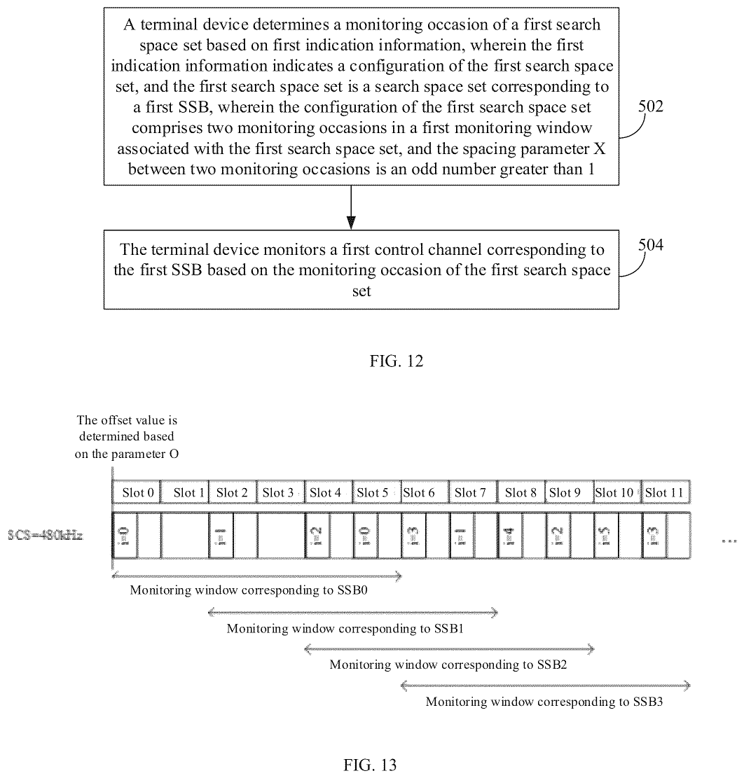

Taking X=5 as an example, FIG. 13 shows a schematic diagram of a monitoring window associated with Type0-PDCCH CSS corresponding to the first SSB (SSB i) in the case that μ=5. As shown in FIG. 13, it is assumed that the offset value determined based on the parameter O is slot 0 (e.g., O=0), and M=2. In the case that i=0, the two monitoring occasions in one monitoring window associated with Type0-PDCCH CSS corresponding to SSB 0 are located in slot 0 and slot 5, respectively; in the case that i=1, the two monitoring occasions in one monitoring window associated with Type0-PDCCH CSS corresponding to SSB 1 are located in slot 2 and slot 7, respectively; in the case that i=2, the two monitoring occasions in one monitoring window associated with Type0-PDCCH CSS corresponding to SSB 2 are located in slot 4 and slot 9, respectively; and in the case that i=3, the two monitoring occasions in one monitoring window associated with Type0-PDCCH CSS corresponding to SSB 3 are located in slot 6 and slot 11, respectively, and the like. In this way, the locations of the two monitoring occasions in one monitoring window associated with Type0-PDCCH CSS corresponding to all SSBs are acquired.

In some embodiments, in the case that μ=6, two slots in a monitoring window associated with Type0-PDCCH CSS corresponding to SSB i are slot n₀ and slot n₀+X, wherein the value of X includes an odd number greater than 8. In some embodiments, the value of X includes an odd number greater than 8 and less than 16. In some embodiments, the value of X includes a smallest odd number greater than 8, i.e., X=9.

In some embodiments, in the case that μ=6, the value of X includes at least one of X=7, X=9, X=11, X=13, or X=15.

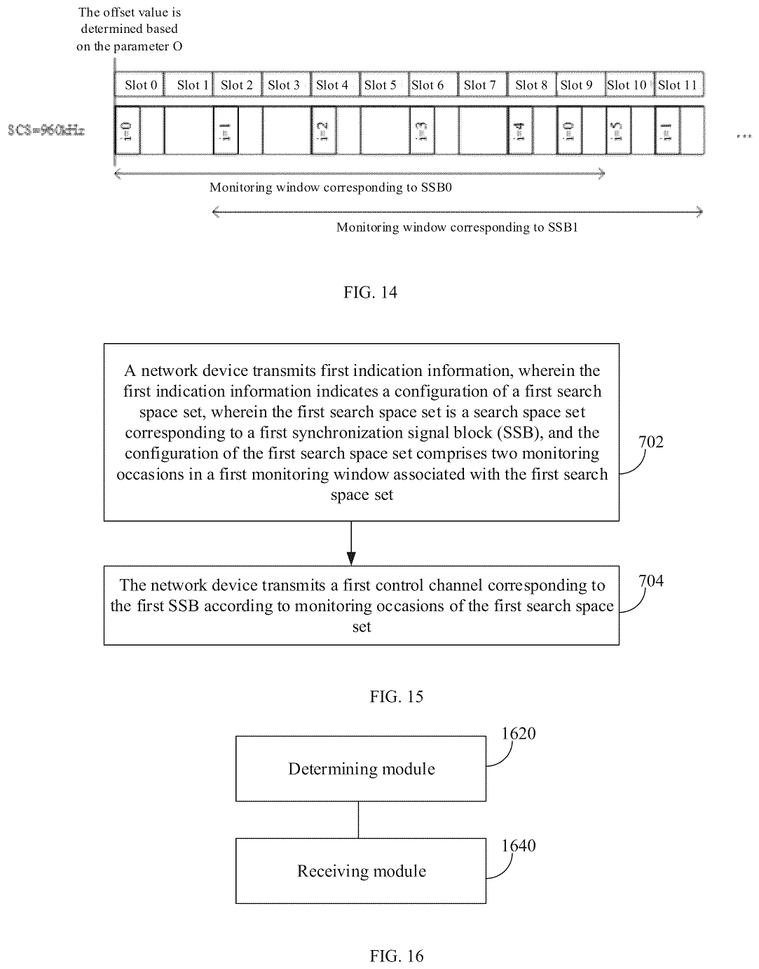

Taking X=9 as an example, FIG. 14 shows a schematic diagram of a monitoring window associated with Type0-PDCCH CSS corresponding to the first SSB (SSB i) in the case that μ=6. As shown in FIG. 14, it is assumed that the offset value determined based on the parameter O is slot 0 (e.g., O=0), and M=2. In the case that i=0, the two monitoring occasions in one monitoring window associated with Type0-PDCCH CSS corresponding to SSB 0 are located in slot 0 and slot 9, respectively; in the case that i=1, the two monitoring occasions in one monitoring window associated with Type0-PDCCH CSS corresponding to SSB 1 are located in slot 2 and slot 11, respectively; accordingly, in the case that i=2, the two monitoring occasions in one monitoring window associated with Type0-PDCCH CSS corresponding to SSB 2 are located in slot 4 and slot 13, respectively; and in the case that i=3, the two monitoring occasions in one monitoring window associated with Type0-PDCCH CSS corresponding to SSB 3 are located in slot 6 and slot 15, respectively, and the like. In this way, the locations of the two monitoring occasions in one monitoring window associated with Type0-PDCCH CSS corresponding to all SSBs are acquired.

In some embodiments, the first indication information further indicates at least one of the following information: a multiplexing pattern, the number N_{RB} of PRBs occupied by the control resource set, the number N_{symb} of symbols occupied by the control resource set, and the starting location of the control resource set on the frequency domain.

For example, the first control resource set is CORESET 0, and the configuration of CORESET 0 includes at least one of: the pattern in which SSB and CORESET 0 are multiplexed, the number N_{RB} of PRBs occupied by CORESET 0, the number N_{symb} of symbols occupied by CORESET 0, and the deviation (in RB, configured to determine the starting PRB of CORESET 0 in the frequency domain) of the SSB lower boundary from the CORESET 0 lower boundary in the frequency domain.

In some embodiments, the parameter X is predefined by a communication protocol.

In process 604, the terminal device monitors a first control channel corresponding to the first SSB based on the monitoring occasion of the first search space set.

Based on the configuration of the first search space set, the terminal device monitors the first control channel corresponding to the first SSB based on the monitoring occasion of the first search space set.

In summary, in the method according to this embodiment, in the case that μ=5 or 6, the parameter X is defined as an odd number greater than 1, such that one monitoring occasion of the first search space set is associated with one SSB. In this way, the problem that in the related art in the case that the subcarrier spacing is 480 kHz or 960 kHz, one monitoring occasion of each of some search space sets is associated with two SSBs and consequently the association of one monitoring occasion of one search space set with one SSB cannot be configured is addressed.

It should be noted that in the embodiments, description is given based on an example in which a time domain unit is a “slot,” and in other embodiments, the time domain unit is also any other possible unit such as a symbol, a symbol group, a slot group, a subframe, or a radio frame. The two embodiments shown in FIGS. 7 and 12 may be combined and implemented as new embodiments.

FIG. 15 shows a flowchart of a method for transmitting a control channel according to some exemplary embodiments of the present disclosure. The method is applicable to a network device, and the method includes the following processes.

In process 702, a network device transmits first indication information, wherein the first indication information indicates a configuration of a first search space set, wherein the first search space set is a search space set corresponding to a first SSB, and the configuration of the first search space set includes two monitoring occasions in a first monitoring window associated with the first search space set.

In some embodiments, the first indication information is carried in MIB information or in an RRC signaling. For example, the RRC signaling is PDCCH-ConfigCommon.

In some embodiments, the first indication information includes pdcch-ConfigSIB1. In some embodiments, the first indication information is carried in MIB information.

In some embodiments, the first indication information includes searchSpaceSIB1 or searchSpaceZero configuration. In some embodiments, the first indication information is carried in PDCCH-ConfigCommon.

In some embodiments, the first search space set is Type0-PDCCH CSS.

In some embodiments, the cycle of the first monitoring window is 20 milliseconds.

In some embodiments, the value of X is predefined or configured by a network device.

In the case that the value of a subcarrier spacing parameter μ is greater than 4, one monitoring occasion in the first monitoring window is associated with one SSB. The subcarrier spacing parameter μ corresponds to the subcarrier spacing of the first search space set.

In the case that the value of μ is 5, the subcarrier spacing of the first search space set is 480 kHz. In the case that the value of μ is 6, the subcarrier spacing of the first search space set is 960 kHz.

In some embodiments, in the case that a value of a subcarrier spacing parameter μ is greater than 4, one monitoring occasion in the first monitoring window is associated with one SSB, and the subcarrier spacing parameter μ corresponds to a subcarrier spacing of the first search space set;

In the case that the value of μ is 5, the subcarrier spacing of the first search space set is 480 kHz; or in the case that the value of μ is 6, the subcarrier spacing of the first search space set is 960 KHz.

In some embodiments, the first indication information indicates at least one of the following parameters, or the configuration of the first search space set is determined based on at least one of the following parameters: a value of a parameter M, wherein the value of the parameter M includes an odd number greater than 1.

In some embodiments, the parameter M is configured to determine the degree of overlapping between the first monitoring window corresponding to the first SSB and a second monitoring window corresponding to a second SSB. Taking the first SSB as SSB i as an example, the parameter M is configured to determine the degree of overlapping between the monitoring windows of SSB i and SSB i+1.

In some embodiments, the value of the parameter M in the first search space set includes an odd number greater than 1. In some embodiments, in the case that the value of μ is greater than 4 (in the case that the SCS corresponding to Type0-PDCCH CSS is greater than 240 kHz), the value of the parameter M in the first search space set includes an odd number greater than 1. For example, in the case that μ=5 (in the case that the SCS corresponding to Type0-PDCCH CSS is 480 kHz) or 6 (in the case that the SCS corresponding to Type0-PDCCH CSS is 960 kHz), the value of the parameter M in the first search space set includes an odd number greater than 1. In some embodiments, in this case, the value of the parameter M in the first search space set does not include: M=2.

In some embodiments, in the case that the value of μ is greater than 4, the value of the parameter M in the first search space set includes 3. For example, in the case that μ=5 or 6, the value of the parameter M in the first search space set includes 3. In some embodiments, in this case, in the case that μ=5, the value of the parameter M in the first search space set includes: M=3. In some embodiments, in this case, the value of the parameter M in the first search space set does not include: M=2. In the case that μ=6, the value of the parameter M in the first search space set includes at least one of M=3, M=5, or M=7. In some embodiments, in this case, the value of the parameter M in the first search space set does not include: M=2.

The value of the parameter M does not include: M=2.

In some embodiments, the first indication information indicates at least one of the following parameters, or the configuration of the first search space set is determined based on at least one of the following parameters:

a value of a parameter O, wherein the parameter O is configured to determine a slot n₀ in which a first monitoring occasion of the two monitoring occasions in the first monitoring window is located, wherein

$$\\ {n}_{0} = ( O \cdot {2}^{{}_{} μ} + ⌊ i \cdot M ⌋ ) mod {N}_{slot}^{{}_{} frame , μ}$$

i represents the index of the first SSB or the candidate index of the first SSB; μ is the subcarrier spacing parameter; and Nₛₗₒₜ^{frame,μ} represents the number of slots in one radio frame determined based on μ.

In some embodiments, the first monitoring occasion of the two monitoring occasions in the first monitoring window is in the slot n₀, and a second monitoring occasion of the two monitoring occasions in the first monitoring window is in a slot n₀+X; and wherein in the case that the value of μ is 5, a value of the parameter X is 4; or in the case that the value of μ is 6, the value of the parameter X is 8.

In some embodiments, the value of X is predefined or configured by a network device.

In some embodiments, the first monitoring occasion of the two monitoring occasions in the first monitoring window is in the slot n₀, and a second monitoring occasion of the two monitoring occasions in the first monitoring window is in a slot n₀+X; and wherein the value of the parameter X includes an odd number greater than 1.

In some embodiments, in the case that the value of the subcarrier spacing parameter μ is 5 (e.g., in the case that the SCS corresponding to Type0-PDCCH CSS is 480 kHz), the value of the parameter X is an odd number greater than 4.

In some embodiments, in the case that the value of the subcarrier spacing parameter μ is 5 (e.g., in the case that the SCS corresponding to Type0-PDCCH CSS is 480 kHz), the value of the parameter X is an odd number greater than 4 and less than 8.

In some embodiments, in the case that the value of the subcarrier spacing parameter μ is 5 (e.g., in the case that the SCS corresponding to Type0-PDCCH CSS is 480 kHz), the value of the parameter X is a smallest odd number greater than 4, that is, the value of the parameter X is 5.

In some embodiments, in the case that the value of the subcarrier spacing parameter μ is 5 (e.g., in the case that the SCS corresponding to Type0-PDCCH CSS is 480 kHz), the value of the parameter X includes one of: 3, 5, or 7.

In some embodiments, in the case that the value of the subcarrier spacing parameter μ is 6 (e.g., in the case that the SCS corresponding to Type0-PDCCH CSS is 960 kHz), the value of the parameter X is an odd number greater than 8.

In some embodiments, in the case that the value of the subcarrier spacing parameter μ is 6 (e.g., in the case that the SCS corresponding to Type0-PDCCH CSS is 960 kHz), the value of the parameter X is an odd number greater than 8 and less than 16.

In some embodiments, in the case that the value of the subcarrier spacing parameter μ is 6 (e.g., in the case that the SCS corresponding to Type0-PDCCH CSS is 960 kHz), the value of the parameter X is a smallest odd number greater than 8, that is, the value of the parameter X is 9.

In some embodiments, in the case that the value of the subcarrier spacing parameter μ is 6 (e.g., in the case that the SCS corresponding to Type0-PDCCH CSS is 960 kHz), the value of the parameter X includes one of 7, 9, 11, 13, or 15.

In process 704, the network device transmits a first control channel corresponding to the first SSB based on a monitoring occasion of the first search space set.

In summary, in the method according to this embodiment, relevant parameters of the search space set are designed to enable the association of one monitoring occasion of the first search space set with one SSB in the case that the subcarrier spacing is greater than 240 kHz. In this way, the problem that in the related art in the case that the subcarrier spacing is 480 kHz or 960 kHz, one monitoring occasion of each of some search space sets is associated with two SSBs and consequently the association of one monitoring occasion of one search space set with one SSB cannot be configured is addressed.

FIG. 16 shows a block diagram of an apparatus for monitoring a control channel according to some exemplary embodiments of the present disclosure. The apparatus is implemented as all or a part of a terminal device, or the apparatus is applicable to a terminal device, and the apparatus includes:

a determining module 1620, configured to determine a monitoring occasion of a first search space set based on first indication information, wherein the first indication information indicates a configuration of the first search space set, and the first search space set is a search space set corresponding to a first SSB, wherein the configuration of the first search space set includes two monitoring occasions in a first monitoring window associated with the first search space sect; and

a receiving module 1640, configured to monitor a first control channel corresponding to the first SSB based on the monitoring occasion of the first search space set.

In some embodiments, in the case that a value of a subcarrier spacing parameter μ is greater than 4, one monitoring occasion in the first monitoring window is associated with one SSB, and the subcarrier spacing parameter μ corresponds to a subcarrier spacing of the first search space set; in the case that the value of μ is 5, the subcarrier spacing of the first search space set is 480 kHz; or in the case that the value of μ is 6, the subcarrier spacing of the first search space set is 960 kHz, wherein u is an integer.

In some embodiments, the first indication information includes pdcch-ConfigSIB1. In some embodiments, the first indication information is carried in MIB information, or the first indication information is carried in PDCCH-ConfigCommon. For example, the first indication information is carried in searchSpaceSIB1 or searchSpaceZero configuration in PDCCH-ConfigCommon. In some embodiments, PDCCH-ConfigCommon is carried in an RRC signaling.

In some embodiments, the first search space set is Type0-PDCCH CSS.

wherein, in the case that the value of a subcarrier spacing parameter μ is greater than 4, one monitoring occasion in the first monitoring window is associated with one SSB. The subcarrier spacing parameter μ corresponds to the subcarrier spacing of the first search space set.

In the case that the value of μ is 5, the subcarrier spacing of the first search space set is 480 kHz. In the case that the value of μ is 6, the subcarrier spacing of the first search space set is 960 kHz.

In some embodiments, in the case that a value of a subcarrier spacing parameter μ is greater than 4, one monitoring occasion in the first monitoring window is associated with one SSB, and the subcarrier spacing parameter μ corresponds to a subcarrier spacing of the first search space set; in the case that the value of μ is 5, the subcarrier spacing of the first search space set is 480 kHz; or, in the case that the value of μ is 6, the subcarrier spacing of the first search space set is 960 kHz.

In some embodiments, the first indication information indicates (or the configuration of the first search space set includes): a value of a parameter M, wherein the value of the parameter M includes an odd number greater than 1; and wherein the parameter M is configured to determine the degree of overlapping between the first monitoring window corresponding to the first SSB and a second monitoring window corresponding to a second SSB, wherein an index of the second SSB is an index of the first SSB plus one, or a candidate index of the second SSB is a candidate index of the first SSB plus one.

In some embodiments, the value of the parameter M includes 3.

In some embodiments, the value of the parameter M is determined based on the value of the subcarrier spacing parameter μ; and wherein in the case that the value of μ is 5, the value of the parameter M includes 3; or in the case that the value of μ is 6, the value of the parameter M includes one of 3, 5, or 7.

In some embodiments, the value of the parameter M does not include 2.

In some embodiments, the first indication information indicates (or the configuration of the first search space set includes) a value of a parameter O, wherein the parameter O is configured to determine a slot n₀ in which a first monitoring occasion of the two monitoring occasions in the first monitoring window is located, wherein

$$\\ {n}_{0} = ( O \cdot {2}^{{}_{} μ} + ⌊ i \cdot M ⌋ ) mod {N}_{slot}^{{}_{} frame , μ}$$

i represents the index of the first SSB or the candidate index of the first SSB; μ is the subcarrier spacing parameter; and Nₛₗₒₜ^{frame,μ} represents the number of slots in one radio frame determined based on μ.

In some embodiments, the first monitoring occasion of the two monitoring occasions in the first monitoring window is in the slot n₀, and a second monitoring occasion of the two monitoring occasions in the first monitoring window is in a slot n₀+X; and wherein in the case that the value of μ is 5, a value of the parameter X is 4; or in the case that the value of μ is 6, the value of the parameter X is 8.

In some embodiments, the first monitoring occasion of the two monitoring occasions in the first monitoring window is in the slot n₀, and a second monitoring occasion of the two monitoring occasions in the first monitoring window is in a slot n₀+X; and wherein the value of the parameter X includes an odd number greater than 1.

In some embodiments, in the case that the value of the subcarrier spacing parameter μ is 5, the value of the parameter X includes one of: an odd number greater than 4; an odd number greater than 4 and less than 8; a smallest odd number greater than 4; or 3 or 5 or 7.

In some embodiments, in the case that the value of the subcarrier spacing parameter μ is 6, the value of the parameter X includes one of: an odd number greater than 8; an odd number greater than 8 and less than 16; a smallest odd number greater than 8; or 7 or 9 or 11 or 13 or 15.

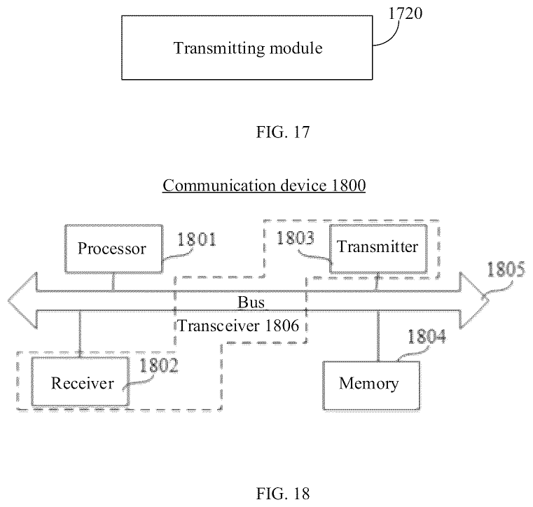

FIG. 17 shows a block diagram of an apparatus for transmitting a control channel according to some exemplary embodiments of the present disclosure. The apparatus is implemented as all or a part of a network device, or the apparatus is applicable to a network device.

The apparatus includes: a transmitting module 1720, configured to transmit first indication information, wherein the first indication information indicates a configuration of a first search space set, wherein the first search space set is a search space set corresponding to a first SSB, and the configuration of the first search space set includes two monitoring occasions in a first monitoring window associated with the first search space set; and the transmitting module 1720, configured to transmit a first control channel corresponding to the first SSB based on a monitoring occasion of the first search space set.

In some embodiments, in the case that a value of a subcarrier spacing parameter μ is greater than 4, one monitoring occasion in the first monitoring window is associated with one SSB, and the subcarrier spacing parameter μ corresponds to a subcarrier spacing of the first search space set; in the case that the value of μ is 5, the subcarrier spacing of the first search space set is 480 kHz; or in the case that the value of μ is 6, the subcarrier spacing of the first search space set is 960 kHz, wherein μ is an integer.

In some embodiments, the first indication information includes pdcch-ConfigSIB1. In some embodiments, the first indication information is carried in MIB information, or the first indication information is carried in PDCCH-ConfigCommon. For example, the first indication information is carried in searchSpaceSIB1 or searchSpaceZero configuration in PDCCH-ConfigCommon. In some embodiments, PDCCH-ConfigCommon is carried in an RRC signaling.

In some embodiments, the first search space set is Type0-PDCCH CSS. wherein, in the case that the value of a subcarrier spacing parameter μ is greater than 4, one monitoring occasion in the first monitoring window is associated with one SSB. The subcarrier spacing parameter μ corresponds to the subcarrier spacing of the first search space set.

In the case that the value of μ is 5, the subcarrier spacing of the first search space set is 480 kHz. In the case that the value of μ is 6, the subcarrier spacing of the first search space set is 960 kHz.

In some embodiments, in the case that a value of a subcarrier spacing parameter μ is greater than 4, one monitoring occasion in the first monitoring window is associated with one SSB, and the subcarrier spacing parameter μ corresponds to a subcarrier spacing of the first search space set; in the case that the value of μ is 5, the subcarrier spacing of the first search space set is 480 kHz; or in the case that the value of μ is 6, the subcarrier spacing of the first search space set is 960 KHz.

In some embodiments, the first indication information indicates (or the configuration of the first search space set includes): a value of a parameter M, wherein the value of the parameter M includes an odd number greater than 1, and the parameter M is configured to determine the degree of overlapping between the first monitoring window corresponding to the first SSB and a second monitoring window corresponding to a second SSB, wherein an index of the second SSB is an index of the first SSB plus one, or a candidate index of the second SSB is a candidate index of the first SSB plus one.

In some embodiments, the value of the parameter M includes 3.

In some embodiments, the value of the parameter M is determined based on the value of the subcarrier spacing parameter μ; and wherein in the case that the value of μ is 5, the value of the parameter M includes 3; or in the case that the value of μ is 6, the value of the parameter M includes one of: 3, 5, or 7.

In some embodiments, the value of the parameter M does not include 2.

In some embodiments, the first indication information indicates (or the configuration of the first search space set includes): a value of a parameter O, wherein the parameter O is configured to determine a slot n₀ in which a first monitoring occasion of the two monitoring occasions in the first monitoring window is located, wherein

$$\\ {n}_{0} = ( O \cdot {2}^{{}_{} μ} + ⌊ i \cdot M ⌋ ) mod {N}_{slot}^{{}_{} frame , μ}$$

i represents the index of the first SSB or the candidate index of the first SSB; μ is the subcarrier spacing parameter; and Nₛₗₒₜ^{frame,μ} represents the number of slots in one radio frame determined based on μ.

In some embodiments, the first monitoring occasion of the two monitoring occasions in the first monitoring window is in the slot n₀, and a second monitoring occasion of the two monitoring occasions in the first monitoring window is in a slot n₀+X; and wherein in the case that the value of μ is 5, a value of the parameter X is 4; or in the case that the value of μ is 6, the value of the parameter X is 8.

In some embodiments, the first monitoring occasion of the two monitoring occasions in the first monitoring window is in the slot n₀, and a second monitoring occasion of the two monitoring occasions in the first monitoring window is in a slot n₀+X; and wherein the value of the parameter X includes an odd number greater than 1.

In some embodiments, in the case that the value of the subcarrier spacing parameter μ is 5, the value of the parameter X includes one of: an odd number greater than 4; an odd number greater than 4 and less than 8; a smallest odd number greater than 4; or 3 or 5 or 7.

In some embodiments, in the case that the value of the subcarrier spacing parameter μ is 6, the value of the parameter X includes one of: an odd number greater than 8; an odd number greater than 8 and less than 16; a smallest odd number greater than 8; or 7 or 9 or 11 or 13 or 15.

FIG. 18 shows a schematic structural diagram of a communication device (a terminal device or a network device or an access network device) according to some exemplary embodiments of the present disclosure. For example, the communication device is configured to perform the method for monitoring a control channel as described above. Specifically, the communication device 1800 includes a processor 1801, a receiver 1802, a transmitter 1803, a memory 1804, and a bus 1805.

The processor 1801 includes one or more processing cores. The processor 1801 runs various functional applications and perform information processing by running software programs and modules.

The receiver 1802 and the transmitter 1803 may be practiced as a transceiver 1806, which may be a communication chip.

The memory 1804 is connected to the processor 1801 over the bus 1805.

The memory 1804 is configured to store one or more computer programs. The processor 1801 is configured to execute the one or more computer programs to perform the processes of the method for monitoring a control channel performed by the terminal device or the network device or the access network device in the above method embodiments.

The transmitter 1803 is configured to perform the processes associated with the transmission in the above method embodiments; the receiver 1802 is configured to perform the processes associated with the reception in the above method embodiments; and the processor 1801 is configured to perform the other processes other than the transmission and reception processes in the above embodiments.

Furthermore, the memory 1814 is implemented by any type of volatile or non-volatile storage device or a combination thereof. The volatile or non-volatile storage device includes but not limited to: a random-access memory (RAM), a read-only memory (ROM), an erasable programmable read-only memory (EPROM), an electrically erasable programmable read-only memory (EEPROM), a flash memory or other solid-state memory technologies, a compact disc read-only memory (CD-ROM), a digital video disc (DVD) or other optical storage, magnetic cassette, magnetic tape, magnetic disk storage or other magnetic storage devices.

In some exemplary embodiments, a network device is further provided. The network device includes: a processor and a memory storing one or more computer program. The processor, when loading and running the one or more computer programs, is caused to perform the method for transmitting a control channel as described above.

In some exemplary embodiments, a terminal device is further provided. The terminal device includes: a processor and a memory storing one or more computer programs. The processor, when loading and running the one or more computer programs, is caused to perform the method for monitoring a control channel as described above.

The present disclosure further provides a non-transitory computer-readable storage medium. The computer-readable storage medium stores at least one instruction, at least one program, a code set, or an instruction set. The at least one instruction, the at least one program, the code set, or the instruction set, when loaded and executed by a processor, causes the processor to perform the method for monitoring a control channel or the method for transmitting a control channel according to the above method embodiments.

The present disclosure further provides a computer program product. The computer program product includes one or more computer instructions. The one or more computer instructions are stored in a computer-readable storage medium. The one or more computer instructions, when read and executed by a processor of a computer device, cause the computer device to perform the method for monitoring a control channel or the method for transmitting a control channel as described above.

The serial numbers of the embodiments of the present disclosure are merely for description, and do not represent the advantages and disadvantages of the embodiments.

Those of ordinary skill in the art understand that, all or a part of the processes for implementing the above embodiments are completed by hardware, or are completed by instructing relevant hardware by a program stored in a computer-readable storage medium. The storage medium mentioned above is a read-only memory, a magnetic disk, a compact disk, or the like.

Described above are merely optional embodiments of the present disclosure and are not intended to limit the present disclosure. Any modifications, equivalents, improvements, and the like, made within the spirit and principle of the present disclosure should fall within the protection scope of the present disclosure.

1. A method for monitoring a control channel, comprising:
determining, by a terminal device, a monitoring occasion of a first search space set based on first indication information, wherein the first indication information indicates a configuration of the first search space set, and the first search space set is a search space set corresponding to a first synchronization signal block (SSB), wherein the configuration of the first search space set comprises two monitoring occasions in a first monitoring window associated with the first search space set; and
monitoring, by the terminal device, a first control channel corresponding to the first SSB based on the monitoring occasion of the first search space set.

2. The method according to claim 1, wherein in a case that a value of a subcarrier spacing parameter μ is greater than 4, one monitoring occasion in the first monitoring window is associated with one SSB, and the subcarrier spacing parameter μ corresponds to a subcarrier spacing of the first search space set; wherein:
in a case that the value of μ is 5, the subcarrier spacing of the first search space set is 480 kHz; or
in a case that the value of μ is 6, the subcarrier spacing of the first search space set is 960 kHz.

3. The method according to claim 1, wherein the first indication information indicates:
a value of a parameter M, the value of the parameter M comprising an odd number greater than 1,
wherein the parameter M is configured to determine a degree of overlapping between the first monitoring window corresponding to the first SSB and a second monitoring window corresponding to a second SSB, wherein an index of the second SSB is an index of the first SSB plus one, or a candidate index of the second SSB is a candidate index of the first SSB plus one.

4. The method according to claim 3, wherein the value of the parameter M is determined based on a value of a subcarrier spacing parameter μ; wherein:
in a case that the value of μ is 5, the value of the parameter M comprises 3; or
in a case that the value of μ is 6, the value of the parameter M comprises one of: 3, 5, or 7.

5. The method according to claim 3, wherein the first indication information indicates:
a value of a parameter O, the parameter O being configured to determine a slot n₀ in which a first monitoring occasion of the two monitoring occasions in the first monitoring window is located, wherein,
$$\\ {n}_{0} = ( O \cdot {2}^{{}_{} μ} + ⌊ i \cdot M ⌋ ) mod {N}_{slot}^{{}_{} frame , μ}$$
wherein i represents the index of the first SSB or the candidate index of the first SSB;
μ represents a subcarrier spacing parameter; and
Nₛₗₒₜ^{frame,μ} represents a number of slots in one radio frame determined based on μ.

6. The method according to claim 1, wherein a first monitoring occasion of the two monitoring occasions in the first monitoring window is in a slot n₀, and a second monitoring occasion of the two monitoring occasions in the first monitoring window is in a slot n₀+X; and wherein:
in a case that a value of μ is 5, a value of parameter X is 4; or
in a case that a value of μ is 6, a value of the parameter X is 8.

7. The method according to claim 1, wherein a first monitoring occasion of the two monitoring occasions in the first monitoring window is in a slot n₀, and a second monitoring occasion of the two monitoring occasions in the first monitoring window is in a slot n₀+X; and
wherein a value of parameter X comprises an odd number greater than 1.

8. The method according to claim 7, wherein in a case that a value of a subcarrier spacing parameter μ is 5, the value of the parameter X comprises one of:
an odd number greater than 4;
an odd number greater than 4 and less than 8;
a smallest odd number greater than 4; or
3 or 5 or 7.

9. The method according to claim 7, wherein in a case that a value of a subcarrier spacing parameter μ is 6, the value of the parameter X comprises one of:
an odd number greater than 8;
an odd number greater than 8 and less than 16;
a smallest odd number greater than 8; or
7 or 9 or 11 or 13 or 15.

10. A terminal device, comprising:
a processor and a memory storing one or more computer programs therein, wherein the one or more computer programs, when executed by the processor, cause the terminal device to:
determine a monitoring occasion of a first search space set based on first indication information, wherein the first indication information indicates a configuration of the first search space set, and the first search space set is a search space set corresponding to a first synchronization signal block (SSB), wherein the configuration of the first search space set comprises two monitoring occasions in a first monitoring window associated with the first search space set; and
monitor a first control channel corresponding to the first SSB based on the monitoring occasion of the first search space set.

11. The terminal device according to claim 10, wherein in a case that a value of a subcarrier spacing parameter μ is greater than 4, one monitoring occasion in the first monitoring window is associated with one SSB, and the subcarrier spacing parameter μ corresponds to a subcarrier spacing of the first search space set; wherein:
in a case that the value of μ is 5, the subcarrier spacing of the first search space set is 480 kHz; or
in a case that the value of μ is 6, the subcarrier spacing of the first search space set is 960 kHz.

12. The terminal device according to claim 10, wherein the first indication information indicates:
a value of a parameter M, the value of the parameter M comprising an odd number greater than 1,
wherein the parameter M is configured to determine the degree of overlapping between the first monitoring window corresponding to the first SSB and a second monitoring window corresponding to a second SSB, wherein an index of the second SSB is an index of the first SSB plus one, or a candidate index of the second SSB is a candidate index of the first SSB plus one.

13. A network device, comprising:
a processor and a memory storing one or more computer programs therein, wherein the one or more computer programs, when executed by the processor, cause the network device to:
transmit first indication information, wherein the first indication information indicates a configuration of a first search space set, wherein the first search space set is a search space set corresponding to a first synchronization signal block (SSB), and the configuration of the first search space set comprises two monitoring occasions in a first monitoring window associated with the first search space set; and
transmit a first control channel corresponding to the first SSB based on a monitoring occasion of the first search space set.

14. The network device according to claim 13, wherein in a case that a value of a subcarrier spacing parameter μ is greater than 4, one monitoring occasion in the first monitoring window is associated with one SSB, and the subcarrier spacing parameter μ corresponds to a subcarrier spacing of the first search space set; wherein:
in a case that the value of μ is 5, the subcarrier spacing of the first search space set is 480 kHz; or
in a case that the value of μ is 6, the subcarrier spacing of the first search space set is 960 kHz.

15. The network device according to claim 13, wherein the first indication information indicates:
a value of a parameter M, the value of the parameter M comprising an odd number greater than 1,
wherein the parameter M is configured to determine a degree of overlapping between the first monitoring window corresponding to the first SSB and a second monitoring window corresponding to a second SSB, wherein an index of the second SSB is an index of the first SSB plus one, or a candidate index of the second SSB is a candidate index of the first SSB plus one.

16. The network device according to claim 15, wherein the value of the parameter M comprises 3.

17. The network device according to claim 15, wherein the value of the parameter M does not comprise 2.

18. The network device according to claim 13, wherein the first search space set comprises Type0-PDCCH CSS.

19. The network device according to claim 13, wherein the first indication information comprises pdcch-ConfigSIB1.

20. The network device according to claim 13, wherein:
the first indication information is carried in a master information block (MIB); or
the first indication information is carried in PDCCH-ConfigCommon.
